(19) United States
(12) Patent Application Publication
(10) Pub. No.: US 2011/0318009 A1
(43) Pub. Date: Dec. 29, 2011

(54) PON SYSTEM, OPTICAL NETWORK UNIT USED THEREIN, AND TRANSMISSION CONTROL METHOD THEREFOR

(76) Inventor: Shingo Shiba, Osaka-shi (JP)

(21) Appl. No.: 13/148,861

(22) PCT Filed: Nov. 2, 2009
(86) PCT No.: PCT/JP2009/068753

§ 371 Date: Aug. 10, 2011

(30) Foreign Application Priority Data
Feb. 19, 2009 (JP) 2009-036103

(51) Int. Cl. H04J 14/00

(52) U.S. Cl. 398/67

(57) ABSTRACT

An object of the present invention is to improve the accuracy of bandwidth control by an optical line terminal 1 by preventing an optical network unit 2 from performing upstream transmission of an amount of data that is not expected by the optical line terminal 1. The optical network unit 2 of the present invention is an optical network unit in a PON system, which is capable of performing bidirectional optical communication with the optical line terminal 1 through a passive light-splitting node 6, and which performs upstream transmission of a FEC frame including a variable length frame to the optical line terminal 1. The optical network unit 2 includes a grant processing unit 207 that determines whether an amount of allocation specified in a grant G1 which is a report request is one unit amount of data (one FCW) of the FEC frame; and a frame transmitting unit 206 that transmits only a report R to the optical line terminal 1 if a result of the determination is affirmative.

### TECHNICAL FIELD

The present invention relates to a PON (Passive Optical Network) system, an optical network unit included in the PON system, and a transmission control method performed by the optical network unit for upstream transmission.

### BACKGROUND ART

A PON system including an optical line terminal; an optical fiber network forming a configuration in which an optical fiber connected to the optical line terminal is split into a plurality of optical fibers by an optical coupler; and optical network units connected to the respective ends of the split optical fibers is already implemented.

The optical line terminal in the PON system dynamically allocates bandwidth in an upstream direction to the plurality of optical network units in a time-division manner, to prevent upstream signal interference.

Specifically, the optical line terminal receives from each optical network unit in advance a control frame for a bandwidth request (a report: also referred to as a request) which specifies an amount of data to be sent out in the upstream direction, determines a bandwidth to be allocated to each optical network unit based on the amount of data (request value) specified in each report, and provides notification (grant) of transmission permitted bandwidths.

Since each grant includes a transmission start time and a transmission permitted length (a value corresponding to a period of time), each optical network unit can send out a predetermined amount of data in the upstream direction during a predetermined period of time specified in a corresponding grant (see, for example, Patent Literature 1).

Each grant includes a data area called a flag field (“Number of grants/Flags” in FIG. 3B). The flag field is an identifier by which an optical network unit identifies the type of a gate frame transmitted by the optical line terminal.

When the optical line terminal wants an optical network unit to transmit a report, the optical line terminal sets a predetermined value other than 0 in the flag field. Such a flag field forcing transmission of a report is referred to as a “force report”.

Meanwhile, a 10 G-EPON system complying with IEEE802.3av adopts a scheme in which link budget which becomes insufficient due to an increase in communication speed is compensated for by Forward Error Correction (FEC) encoding technology. Each optical network unit performs upstream transmission to the optical line terminal using FEC frames, each including an Ethernet (“Ethernet” is a registered trademark, ditto hereinafter) frame which is a variable length frame.

In the FEC frames, the amount of data transmitted is determined by a unit amount of data called a FEC code word (hereinafter, the unit may be abbreviated as “FCW”) (see Non-Patent Literature 1).

FIG. 11 is a conceptual diagram of an optical burst signal including the above-described FEC frames.

As shown in FIG. 11, the optical burst signal not only includes FEC data composed of a plurality of FCWs obtained by encoding user data (“FEC protected (N FEC codewords)” in FIG. 11), but is also added with overhead such as the times required for laser on and off (“Laser On” and “Laser Off” in FIG. 11), synchronization time required for synchronization (”Sync Pattern” in FIG. 11) and EOB (End of Burst).

The FEC data is composed of N (natural number) FEC code words, and parity bits are added to the last portion of each FEC code word.

Twenty-seven 66-bit blocks are allocated to the actual data portion of each FEC code word, and an Ethernet frame is stored in the actual data portion. In addition, four 66-bit blocks are allocated to the parity portion of each FEC code word. Therefore, the data length of one FEC code word is 2046 (=66×31) bits.

### CITATION LIST

### Patent Literature

Patent Literature 1: Japanese Patent Application Laid-Open No. 2004-129172

Patent Literature 2: Japanese Patent Application Laid-Open No. 2007-243770 (FIGS. 6 and 7)

### Non-Patent Literature

Non Patent Literature 1: IEEE 802.3 10 G-EPON Task Force, pp 130-132

### SUMMARY OF INVENTION

### Technical Problem

When the unit of the amount of data transmitted is a FEC code word, as in the above-described 10 G-EPON system, even if the optical line terminal grants an amount of allocation smaller than one FEC code word, an optical network unit cannot transmit a frame.

Hence, even when the optical line terminal wants an optical network unit to transmit data smaller than one FEC code word (one FCW), e.g., when the optical line terminal wants an optical network unit to transmit only a report by a grant which is a force report, the optical line terminal always needs to generate a grant specifying an amount of allocation corresponding to one FCW.

As such, while there is a case in which the optical line terminal wants an optical network unit to transmit only a report (hereinafter, referred to as the first case), there is also a case in which, in order to improve bandwidth efficiency in the upstream direction, the optical line terminal wants an optical network unit to transmit an upstream frame where a report and user data are connected (hereinafter, referred to as the second case).

However, since a distinction between the first case and the second case is not specified in a grant, an optical network unit having received a grant which is a force report cannot make a distinction between the first case and the second case.

Due to this, for example, when the optical line terminal notifies of a grant which is a force report with an amount of allocation of one FCW, to allow an optical network unit to transmit only a report, the optical network unit may perform upstream transmission of an amount of data exceeding the amount corresponding to the report within a range smaller than or equal to one FCW.

When the optical network unit thus transmits, using the bandwidth allocated to transmit only a report, an amount of data exceeding the amount corresponding to the report, inconvenience such as that shown below is concerned regarding bandwidth control on the side of the optical line terminal.

Specifically, the amount of data transmitted from each optical network unit becomes inconsistent with a grant generated by the optical line terminal performing predetermined dynamic bandwidth allocation. Thus, the optical line terminal becomes uncertain as to how much bandwidth is allocated for user data, causing a problem of degradation in the accuracy of bandwidth control by the optical line terminal.

In view of the above-described conventional problem, an object of the present invention is to provide an optical network unit capable of improving the accuracy of bandwidth control by an optical line terminal by preventing the optical network unit from performing upstream transmission of an amount of data that is not expected by the optical line terminal, a PON system, and a transmission control method for the optical network unit.

### Solution to Problem

In accordance with an aspect of the present invention, there is provided an optical network unit in a PON system, the optical network unit being capable of performing bidirectional optical communication with an optical line terminal through a passive light-splitting node, and performing upstream transmission of a FEC frame including a variable length frame to the optical line terminal, and including: a grant processing unit that determines whether an amount of allocation specified in a grant is one unit amount of data of the FEC frame, the grant being a report request; and a frame transmitting unit that transmits only a report to the optical line terminal if a result of the determination is affirmative.

According to the optical network unit of the present invention, the grant processing unit determines whether an amount of allocation specified in a grant which is a report request (force report) is one unit amount of data (one FCW) of a FEC frame, and the frame transmitting unit transmits only a report to the optical line terminal if the determination result is affirmative. Thus, in response to a grant which is a report request, the optical network unit does not perform upstream transmission of an amount of data exceeding the amount corresponding to a report.

Hence, the optical network unit can be prevented from performing upstream transmission of an amount of data that is not expected by the optical line terminal, enabling to suppress confusion over bandwidth control caused by the optical line terminal receiving an unexpected amount of data.

Meanwhile, a request value specified in a report by the optical network unit is normally determined to be less than or equal to a preset threshold value, by extracting an amount of data accumulated in the upstream queue.

Hence, when the threshold value is set without taking into account the size of the unit amount of data (FCW) of a FEC frame, a blank time where data transmission cannot be performed may become large in an allocated bandwidth granted by the optical line terminal, which may degrade bandwidth efficiency.

In the above aspect, the optical network unit further includes: a threshold value setting unit that sets a threshold value to a value corresponding to an actual amount of data that can be included in a natural number of FEC frames; and a request processing unit that sets, as a request value specified in the report, an amount of data corresponding to a division of one of variable length frames smaller than or equal to and closest to the set threshold value.

In this case, since the threshold value is set to a value corresponding to the actual amount of data that can be included in a natural number of FEC frames, a blank time where data transmission cannot be performed in an allocated bandwidth determined by the optical line terminal becomes very small, enabling to improve bandwidth efficiency.

Note that the above-described “value corresponding to the actual amount of data” not only refers to the case in which the value exactly matches the actual amount of data, but may be larger than the actual amount of data that can be included in a natural number of FEC frames. However, the closer the value is to this amount of data, the greater the effect of an improvement in bandwidth efficiency is

Meanwhile, a PON system that performs bandwidth control using a “multiple-request scheme” (a scheme in which the optical line terminal performs bandwidth allocation by selecting any of a plurality of request values specified in one report) is known which will be described in a later embodiment, too. In the case of an optical network unit supporting the multiple-request scheme, the request processing unit can set, in the report, a plurality of request values including a priority request value which indicates an amount of data for maximum delay guarantee to which bandwidth is allocated on a priority basis.

In the case of an optical network unit supporting the multiple-request scheme, it is preferable that the grant processing unit determine whether the amount of allocation specified in the grant is larger than or equal to two unit amounts of data of the FEC frames and larger than or equal to a bandwidth required to transmit an amount of data corresponding to both the report and the priority request value, the grant being a report request, and if a result of the determination is affirmative, then the frame transmitting unit transmit an amount of data corresponding to the report and the priority request value to the optical line terminal.

In this case, the grant processing unit determines whether an amount of allocation specified in a grant which is a report request is larger than or equal to two unit amounts of data (two FCWs) of FEC frames and larger than or equal to a bandwidth required to transmit an amount of data corresponding to both a report and a priority request value. If the determination result is affirmative, then the frame transmitting unit transmits an amount of data corresponding to the report and the priority request value to the optical line terminal. Thus, when the optical line terminal has an intention of allowing the optical network unit to transmit user data by a grant which is a report request, the optical network unit can perform upstream transmission of the user data in response to the intension.

In dynamic bandwidth allocation of the multiple-request scheme, even if a grant is provided to the optical network unit by adopting a priority request value, when an amount of allocation in the grant is an amount that allows to transmit a larger amount of data than that reported by the priority request value, the optical network unit may perform upstream transmission of an amount of data exceeding the priority request value without permission.

In this case, too, the optical network unit performs upstream transmission of an amount of data that is not expected by the optical line terminal.

Hence, it is preferable that, in the optical network unit of the present invention, the grant processing unit determine whether an amount of allocation specified in a grant is an amount corresponding to the priority request value, the grant being not a report request, and if a result of the determination is affirmative, then the frame transmitting unit transmit an amount of data corresponding to only the priority request value to the optical line terminal.

In this case, the grant processing unit determines whether an amount of allocation specified in a grant which is not a report request is an amount corresponding to a priority request value. If the determination result is affirmative, then the frame transmitting unit transmits an amount of data corresponding to only the priority request value to the optical line terminal. Thus, in response to a grant which is not a report request, the optical network unit does not perform upstream transmission of an amount of data exceeding the amount corresponding to a priority request value.

Hence, when dynamic bandwidth allocation of the multiple-request scheme is performed, the optical network unit can be prevented from performing upstream transmission of an amount of data that is not expected by the optical line terminal, enabling to suppress confusion over bandwidth control caused by the optical line terminal receiving an unexpected amount of data.

In accordance with another aspect of the present invention, there is provided a PON system including: an optical line terminal; and a plurality of optical network units performing bidirectional optical communication with the optical line terminal through a passive light-splitting node, the optical network units each performing upstream transmission of a FEC frame including a variable length frame to the optical line terminal, wherein when any of the optical network units receives a grant and an amount of allocation specified in the grant is one unit amount of data of the FEC frame, the optical network unit transmits only a report to the optical line terminal, the grant being a report request.

In accordance with still another aspect of the present invention, there is provided a transmission control method for an optical network unit performed when the optical network unit performing bidirectional optical communication with an optical line terminal through a passive light-splitting node performs upstream transmission of a FEC frame including a variable length frame, based on a grant received from the optical line terminal, the transmission control method including: allowing the optical network unit to transmit only a report when an amount of allocation specified in the grant is one unit amount of data of the FEC frame, the grant being a report request.

A PON system of the present invention is a PON system including the above-described optical network unit of the present invention, and provides the same functions and effects as those provided by the optical network unit.

In addition, a transmission control method of the present invention is a transmission control method performed by the above-described optical network unit of the present invention, and provides the same functions and effects as those provided by the optical network unit.

### Advantageous Effects of Invention

As described above, according to the present invention, an optical network unit can be prevented in advance from performing upstream transmission of an amount of data that is not expected by an optical line terminal. Thus, confusion over bandwidth control caused by the optical line terminal receiving an unexpected amount of data is suppressed, enabling to improve the accuracy of bandwidth control by the optical line terminal.

### BRIEF DESCRIPTION OF DRAWINGS

FIG. 1 is a schematic configuration diagram showing an example of a PON system according to an embodiment of the present invention.

FIG. 2 is a block diagram showing the internal functions of an optical line terminal.

FIGS. 3A and 3B are diagrams showing exemplary frame configurations of a report and a grant.

FIG. 4 is a diagram showing the flow of a process performed between the optical line terminal and any one of optical network units.

FIG. 5 is a sequence diagram showing a general centralized-type DBA.

FIG. 6 is a block diagram showing the internal functions of an optical network unit.

FIG. 7 is a flowchart showing the details of a process performed by a grant processing unit.

FIG. 8 is a conceptual diagram showing a data accumulation state in an upstream frame queue.

FIGS. 9A and 9B are correspondence diagrams between the upstream queue state of an optical network unit and an optical burst signal.

FIGS. 10A and 10B are correspondence diagrams between the upstream queue state of an optical network unit and an optical burst signal.

FIG. 11 is a conceptual diagram of an optical burst signal including FEC frames.

### DESCRIPTION OF EMBODIMENTS

[Overall Configuration of a System]

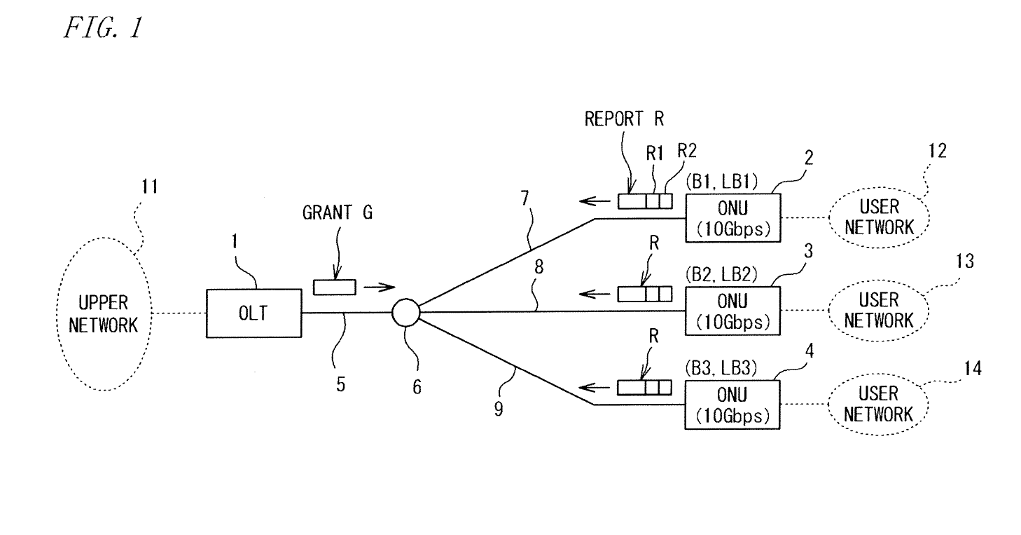

FIG. 1 is a schematic configuration diagram showing an example of a PON system according to an embodiment of the present invention.

In FIG. 1, an optical line terminal 1 is installed as a central station for a plurality of optical network units 2 to 4, and the optical network units 2 to 4 are installed in PON system subscribers' homes, respectively.

A single optical fiber 5 connected to the optical line terminal 1 forms an optical fiber network together with a plurality of optical fibers (branch lines) 7 to 9 split by an optical coupler 6 serving as a passive light-splitting node. The optical network units 2 to 4 are connected to the respective ends of the split optical fibers 7 to 9.

The optical line terminal 1 is connected to an upper network 11, and the optical network units 2 to 4 are connected to their respective user networks 12 to 14.

Note that although FIG. 1 shows three optical network units 2 to 4, it is possible that, for example, 32 split optical fibers are obtained through a single optical coupler 6 to connect 32 optical network units. Note also that although in a connection example shown in FIG. 1 only one optical coupler 6 is used, by longitudinally disposing a plurality of optical couplers with a small number of splits, optical network units distributed in a wide area can also be connected to the optical line terminal 1 with short optical fibers.

The PON system shown in FIG. 1 is a 10 G-EPON system complying with IEEE802.3av. In each of the optical network units 2 to 4, the highest transmission rate in an upstream direction to the optical line terminal 1 is 10 Gbps.

Therefore, access control performed on the optical network units 2 to 4 by the optical line terminal 1 is basically performed according to a 10 G-EPON communication system.

Specifically, each of the optical network units 2 to 4 specifies an amount of data (request value) of which the unit wants to perform upstream transmission to the optical line terminal 1, in a report R (a control frame used by the optical network unit 2 to make a bandwidth request: also referred to as a “request”) in 2-byte units. Based on the report R, the optical line terminal 1 performs predetermined bandwidth allocation and specifies a transmission permitted length and a transmission start time which are the allocation results, in a grant G (a control frame used by the optical line terminal 1 to provide transmission permission) in 2-byte units.

In addition, the times of the optical line terminal 1 and the optical network units 2 to 4 are represented by a PON counter (not shown) which is incremented every predetermined time unit (TQ: Time Quanta=16 ns), and synchronization is achieved in the system.

Furthermore, the PON system of the present embodiment adopts a multiple-request scheme where, for example, each of the optical network units 2 to 4 specifies, in one report R, a plurality of request values R1 and R2 (which may be three or more values) including an amount of buffer with an upper limit (priority request value R1) for supporting communication services requiring low latency such as IP phones, and the optical line terminal 1 performs bandwidth allocation by selecting any of the request values R1 and R2.

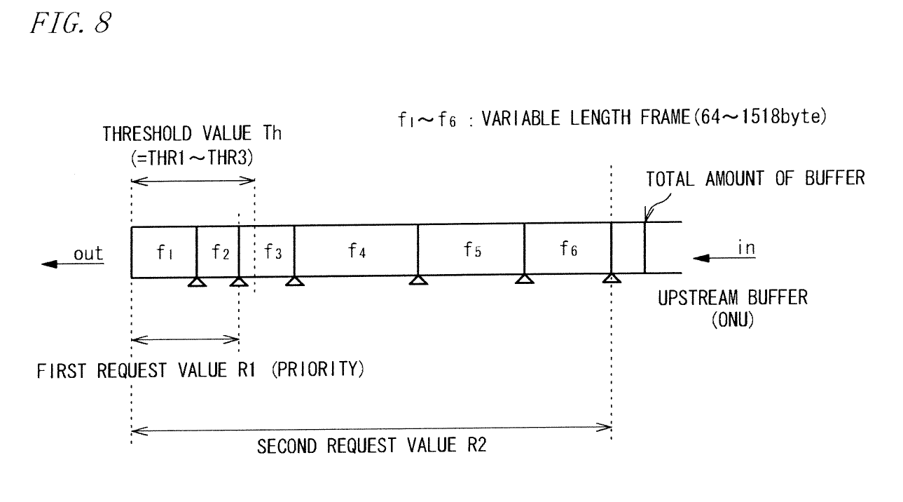

Accordingly, threshold values Th (=THR1 to THR3) for determining a priority request value R1 are set for the optical network units 2 to 4, respectively (see FIG. 8).

[Configuration of the Optical Line Terminal]

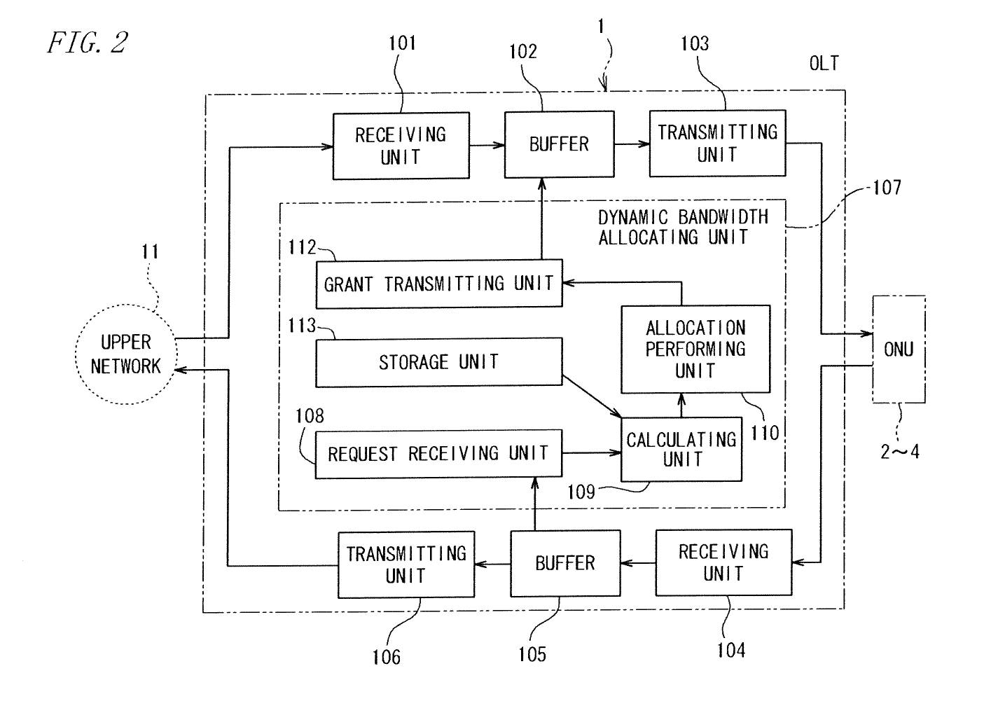

FIG. 2 is a block diagram showing the internal functions of the optical line terminal 1 of the present embodiment.

In FIG. 2, the optical line terminal 1 includes, for downstream signal processing from the upper network 11 to the optical network units 2 to 4, a receiving unit 101 that receives signals from the upper network 11; a buffer 102 that temporarily stores the received signals; and a transmitting unit 103 that transmits the signals temporarily stored in the buffer 102 to the optical network units 2 to 4.

In addition, the optical line terminal 1 includes, for upstream signal processing from the optical network units 2 to 4 to the upper network 11, a receiving unit 104 that receives signals from the optical network units 2 to 4; a buffer 105 that temporarily stores the received signals; and a transmitting unit 106 that transmits the signals temporarily stored in the buffer 105 to the upper network 11.

The optical line terminal 1 further includes a dynamic bandwidth allocating unit 107 that dynamically performs bandwidth allocation on the optical network units 2 to 4 managed by the optical line terminal 1.

The dynamic bandwidth allocating unit 107 includes a request receiving unit 108, a calculating unit 109, an allocation performing unit 110, a grant transmitting unit 112, and a storage unit 113. The storage unit 113 stores minimum guaranteed bandwidths of the optical network units 2 to (in the example of FIG. 1, B1, B2, and B3) and maximum delay guaranteed bandwidths (in the example of FIG. 1, LB1, LB2, and LB3) in a predetermined reference table.

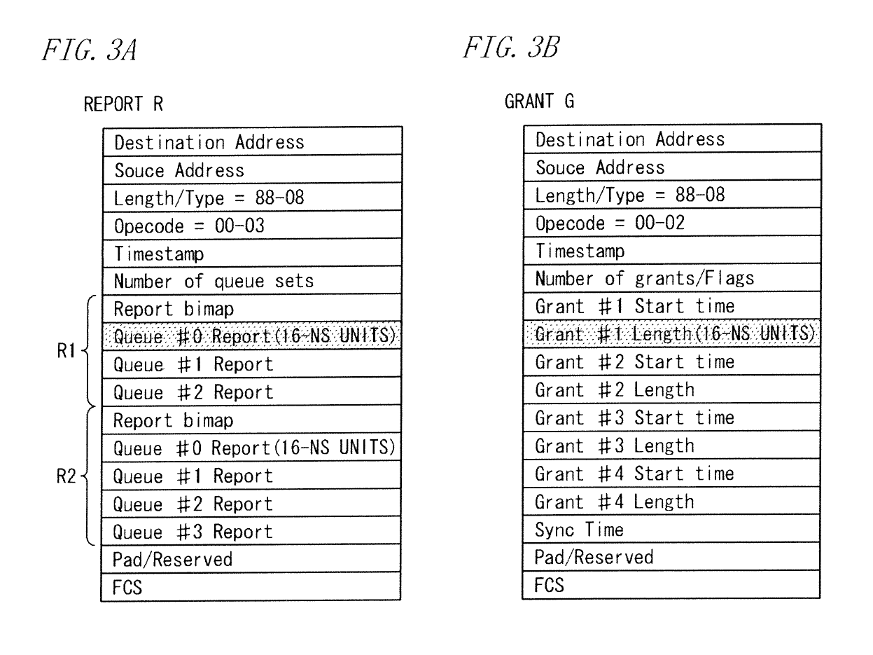

FIG. 3A is a diagram showing an exemplary frame configuration of a report R transmitted by the optical network units 2 to 4, and FIG. 3B is a diagram showing an exemplary frame configuration of a grant G transmitted by the optical line terminal 1.

As shown in FIG. 3A, in the report R of the optical network units 2 to 4, there are two types (in the present embodiment “Number of queue sets”) of amounts of data (request values R1 and R2) for which a bandwidth request is made in one report R, and each is represented by a numerical value in 16-ns units.

Of the two types of request values R1 and R2, the second request value R2 is, in the present embodiment, to specify a maximum amount of data where a MAC frame (Ethernet frame) is not divided, with a maximum data size allowed for upstream transmission in one grant cycle being an upper limit.

The first request value R1, on the other hand, is to specify an amount of data smaller than or equal to the second request value R2. In the present embodiment, the first request value R1 specifies a maximum amount of data where a MAC frame is not divided (a maximum amount of accumulation accumulated in the upstream buffer), with an amount of data corresponding to one of the maximum delay guaranteed bandwidths LB1 to LB3 in one grant cycle being an upper limit. Note that details of the request values R1 and R2 will be described later.

On the other hand, as shown in FIG. 3B, in the grant G transmitted by the optical line terminal 1, a transmission permitted length (a value corresponding to a period of time) for each of the optical network units 2 to 4 is represented by a numerical value in 16-nanosecond units (see Grants #1 to #4 in FIG. 3B).

In addition, the grant G of the optical line terminal 1 includes a data area which is generally called a flag field (“Number of grants/Flags” in FIG. 3B).

The flag field is a field (identifier) used to allow the optical network units 2 to 4 to identify the type of a gate frame transmitted by the optical network unit 1. For example, when the optical line terminal 1 wants the optical network units 2 to 4 to transmit reports R, the optical line terminal 1 sets a corresponding bit in the flag field to 1. The flag field thus provided in a grant G to force each of the optical network units 2 to 4 to transmit a report R is referred to as a “force report”.

Returning to FIG. 2, in the optical line terminal 1 of the present embodiment, reports R specifying the amounts of data that the optical network units 2 to 4 want to send out in the upstream direction (including request values R1 and R2) are received by the request receiving unit 108 in the dynamic bandwidth allocating unit 107 through the receiving unit 104 and the buffer 105, and are then passed over to the calculating unit 109.

The calculating unit 109 calculates allocation priorities by referring to the minimum guaranteed bandwidths B1 to B3 of the optical network units 2 to 4 stored in the storage unit 113, such that the cumulative amount for allocation to the optical network units 2 to 4 approaches the ratio between the minimum guaranteed bandwidths B1 to B3 of the optical network units 2 to 4.

Then, the allocation performing unit 110 in the dynamic bandwidth allocating unit 107 first performs, for the optical network units 2 to 4, bandwidth allocation using the first request values R1. If, by this, surplus bandwidth occurs, then the allocation performing unit 110 performs allocation using the second request values R2 instead of the first request values R1, on the optical network units 2 to 4 in order of the above-described allocation priorities, and thereby generates grants G, each including a transmission start time and a transmission permitted length which is a value corresponding to a period of time.

The grants G each specifying the transmission permitted length which is a value corresponding to a period of time are sent out by the grant transmitting unit 112 to corresponding optical network units 2 to 4 through the buffer 102 and the transmitting unit 103. The optical network units 2 to 4 having received instructions by the grants G send out data in the upstream direction based on the transmission start times and the transmission permitted lengths (periods of time) specified in the respective grants G.

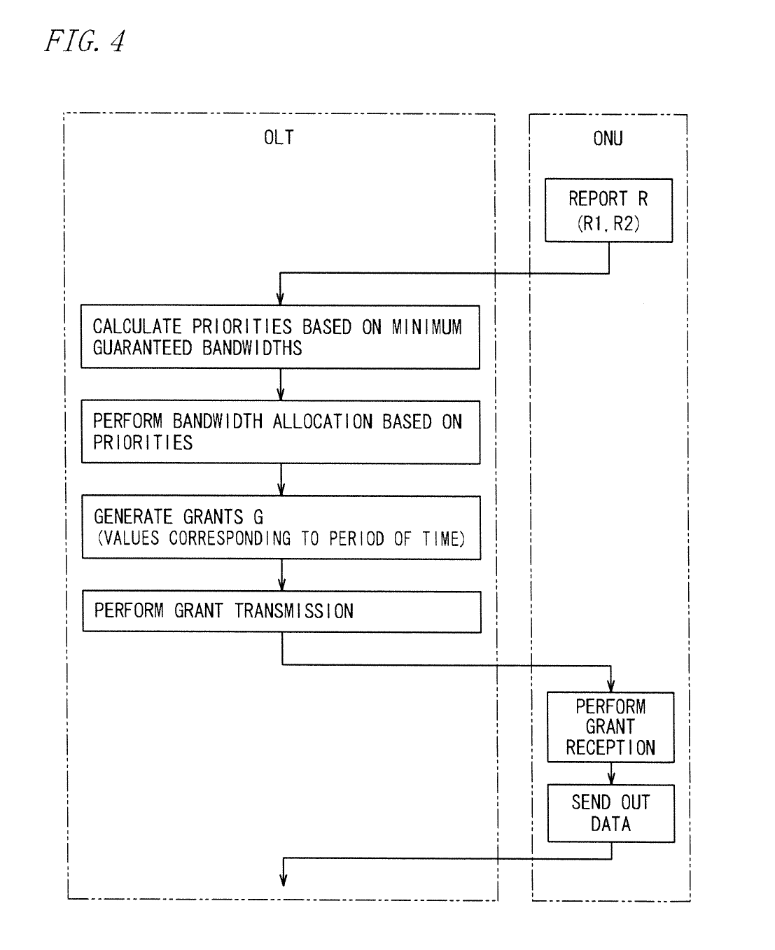

FIG. 4 is a diagram showing the flow of a process for the above-described dynamic bandwidth allocation, which is viewed between the optical line terminal 1 and any one of the optical network units 2 to 4.

As shown in FIG. 4, after the optical line terminal 1 receives reports R (each including first and second request values R1 and R2) from the optical network units 2 to 4, the optical line terminal 1 sequentially performs calculation of priorities based on the minimum guaranteed bandwidths, execution of bandwidth allocation based on the priorities, and generation of grants G, and performs grant transmission to the optical network units 2 to 4 in an amount corresponding to a period of time.

[For Centralized-Type DBA]

Meanwhile, as described above, dynamic bandwidth allocation methods performed by the optical line terminal 1 in response to bandwidth requests (requests) from the optical network units 2 to 4 include a decentralized-type DBA (Dynamic Bandwidth Allocation) and a centralized-type DBA. In the PON system of the present embodiment, the allocation performing unit DO in the dynamic bandwidth allocating unit 107 performs bandwidth control by the centralized-type DBA.

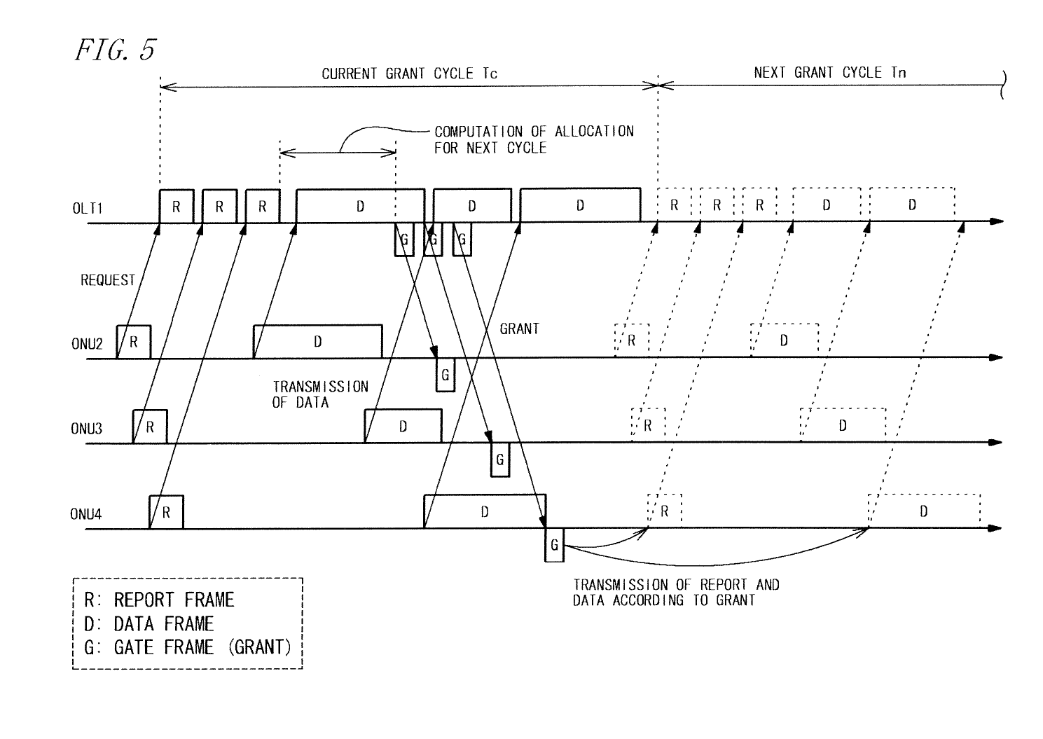

FIG. 5 is a sequence diagram showing the centralized-type DBA.

In FIG. 5, time proceeds from the left to the right.

In addition, a grant cycle which is a bandwidth control cycle of the optical line terminal 1 is represented by the symbol T, the current grant cycle is represented by the symbol Tc (the subscript c refers to “current”), and the next grant cycle is represented by Tn (the subscript n refers to “next”).

As shown in FIG. 5, in the centralized-type DBA, in the current grant cycle Tc, the optical line terminal 1 receives reports R from the optical network units 2 to 4 first in a collective manner. At the point in time when the optical line terminal 1 finishes receiving the reports R, the optical line terminal 1 starts computation of allocation for the next cycle.

Then, the optical line terminal 1 generates grants G specifying the computation results obtained in the current grant cycle Tc, and transmits the grants G to the optical network units 2 to 4 to notify the optical network units 2 to 4 of the next bandwidth allocation for reports R and data (upstream user data) D.

Specifically, the optical line terminal 1 performing the centralized-type DBA integrally performs, based on the reports R collected from the plurality of optical network units 2 to 4 in the current grant cycle Tc, bandwidth allocation for upstream data D of the optical network units 2 to 4 which is to be received by the optical line terminal 1 in the next grant cycle Tn, and grants the next transmission times of reports R and upstream data D to the optical network units 2 to 4.

At this time, in order that the optical network units 2 to 4 can perform upstream transmission while maintaining low latency, the optical line terminal 1 provides at least priority request values R1 by the grants G.

For the amounts of data exceeding the priority request values R1, the optical line terminal 1 performs bandwidth control such that bandwidth is allocated among the optical network units 2 to 4 requesting for bandwidth exceeding the priority request values R1, according to the ratio between the minimum guaranteed bandwidths B1 to B3 set for the optical network units 2 to 4 (priorities).

[Types of Grant by the Optical Line Terminal and Problems]

In the PON system of the present embodiment, grants G provided by the optical line terminal 1 to the optical network units 2 to 4 include the following two types, G1 and G2.

(1) Grant G1 which is a force report (force to transmit a report)

(2) Grant G2 which is not a force report (force to transmit a report)

Of the two types of grants G1 and G2, the grant G1 is a grant G including a force report in which a predetermined bit in the flag field is set to 1, and the grant G2 is a grant G with no force report in which a predetermined bit value in the flag field is 0.

Therefore, each of the optical network units 2 to 4 having received a given grant G can determine which one of the above-described (1) and (2) upstream transmissions is instructed by the optical line terminal 1, by whether the flag field in the grant G indicates a force report.

[Problem with Grant G1]

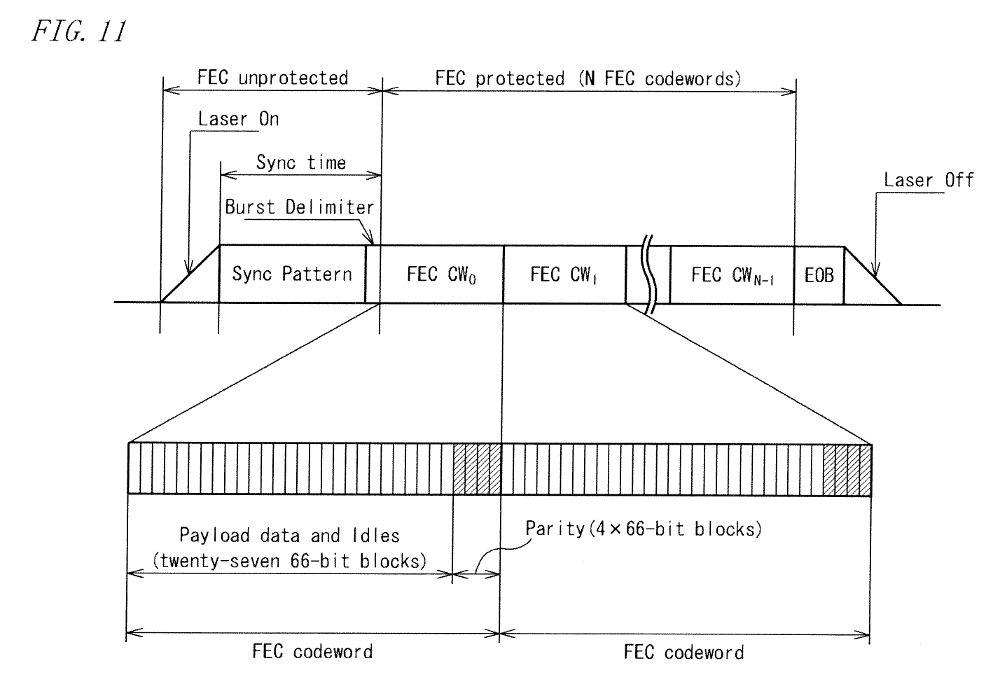

However, in the case of the 10 GE-PON system such as that in the present embodiment, since the unit of the amount of data transmitted is a FEC code word (see FIG. 11), even when the optical line terminal wants the optical network units 2 to 4 to transmit only reports R by grants G1, the optical line terminal cannot grant an amount of allocation smaller than one FCW (a value corresponding to a period of time) to the optical network units 2 to 4.

Hence, for example, even when the optical line terminal 1 wants the optical network units 2 to 4 to transmit data smaller than one FEC code word (one FCW), such as the case (first case) in which the optical line terminal 1 wants the optical network units 2 to 4 to transmit only reports R by grants G1, the optical line terminal 1 always needs to generate grants G1 with an amount of allocation corresponding to one FCW.

Meanwhile, a force report is an identifier forcing transmission of a report R but is not that denying transmission of user data D together therewith. Hence, when the optical network units 2 to 4 receive grants G1 which are force reports and there is an allowance for the amounts of allocation in the grants G1, the optical network units 2 to 4 can also include user data D at the same time.

For example, in the case (second case) in which, in order to improve bandwidth efficiency in the upstream direction, the optical line terminal 1 wants each of the optical network units 2 to 4 to transmit an upstream frame where a report R and user data D are connected, the optical line terminal 1 allocates an amount of allocation for the report R and the user data D in a grant G1.

However, the grant G1 which is a force report does not have a data area specifying a distinction between the first case in which transmission of only a report R is allowed and the second case in which transmission of user data D is also allowed at the same time. Thus, the optical network units 2 to 4 having received the grants G1 which are force reports cannot make a distinction between the first case and the second case.

Due to this, for example, when the optical line terminal 1 notifies of a grant G1 which is a force report with an amount of allocation of one FCW, to allow each of the optical network units 2 to 4 to transmit only a report R, each of the optical network units 2 to 4 may perform upstream transmission of an amount of data exceeding the amount corresponding to the report R within a range smaller than or equal to one FCW.

When each of the optical network units 2 to 4 thus transmits, using the bandwidth allocated to transmit only a report R, an amount of data exceeding the amount corresponding to the report R without permission, the amounts of data transmitted from the optical network units 2 to 4 become inconsistent with grants G1 generated by the optical line terminal 1 performing predetermined dynamic bandwidth allocation.

Accordingly, in this case, the optical line terminal 1 becomes uncertain as to how much bandwidth is allocated for user data D, degrading the accuracy of bandwidth control by the optical line terminal 1.

[Problem with Grant G2]

On the other hand, the optical network units 2 to 1 having received grants G2 which are not force reports perform upstream transmission of only user data D without transmitting reports R.

In this case, assuming the case in which, in dynamic bandwidth allocation of the multiple-request scheme, a grant G2 adopting a priority request value R1 is provided to a given one of the optical network units 2 to 1, the optical network units 2 to 4 may perform upstream transmission of an amount of data exceeding the priority request value R1 without permission.

When each of the optical network units 2 to 4 thus transmits, using the bandwidth allocated to transmit an amount of data corresponding to a priority request value R1, an amount of data exceeding the amount corresponding to the request value R1 without permission, the amounts of data transmitted from the optical network units 2 to 4 become inconsistent with grants G2 generated by the optical line terminal 1 performing predetermined dynamic bandwidth allocation.

Accordingly, in this case, too, the optical line terminal 1 becomes uncertain as to how much bandwidth is allocated for user data D, degrading the accuracy of bandwidth control by the optical line terminal 1.

Hence, in the present embodiment, the optical network units 2 to 4 make a distinction between the first case and the second case from an amount of allocation in a grant G1 which is a force report, and thereby perform accurate upstream transmission taking into account the intention of the optical line terminal 1.

In addition, in the present embodiment, the optical network units 2 to 4 determine from an amount of allocation in a grant G2 which is not a force report whether the amount corresponds to a priority request value and thereby perform accurate upstream transmission taking into account the intention of the optical line terminal 1.

[Configuration of an Optical Network Unit]

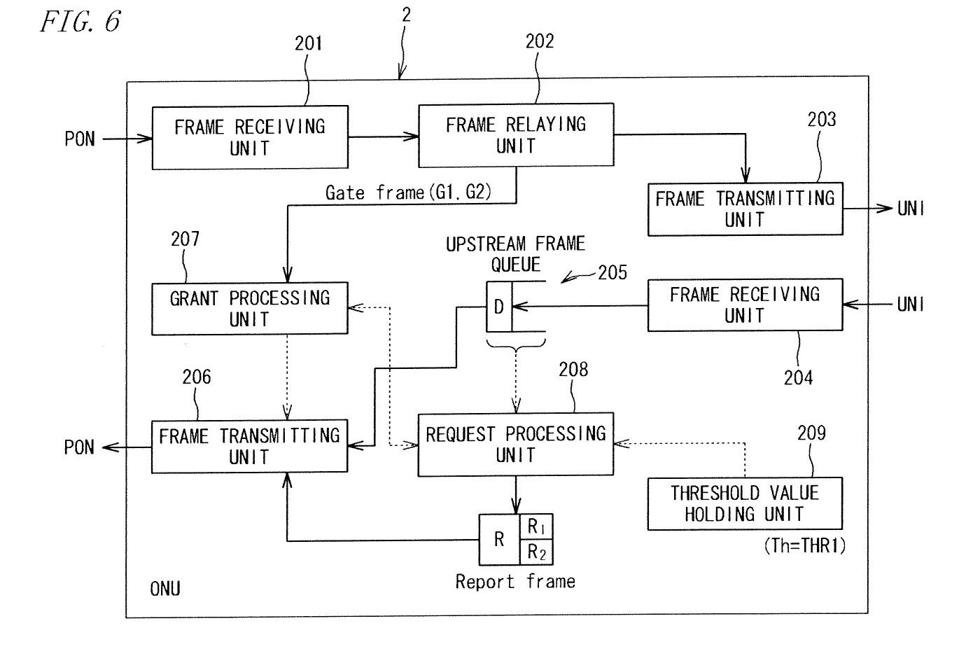

FIG. 6 is a block diagram showing the internal functions of the optical network unit 2 of the present embodiment.

Note that in FIG. 6 a solid line arrow indicates a signal transmission direction and a dashed line arrow indicates a data reference direction between functional blocks. Note also that although FIG. 6 shows a configuration of only one optical network unit 2, the configuration is also the same for other optical network units 3 and 4.

As shown in FIG. 6, the optical network unit 2 includes, for downstream signal processing from the PON side to the user network side (UNI side), a frame receiving unit 201 that receives a signal from the PON side; a frame relaying unit 202 that temporarily stores the received signal and relays the signal; and a frame transmitting unit 203 that transmits a user frame of the temporarily stored signal to the UNI side.

In addition, the optical network unit 2 includes, for upstream signal processing from the UNI side to the PON side, a frame receiving unit 204 that receives a signal from the UNI side; an upstream frame queue 205 that temporarily stores the received signal; and a frame transmitting unit 206 that transmits the temporarily stored signal to the PON side.

A gate frame, which is a PON control frame, of the downstream signal temporarily stored in the frame relaying unit 202 is sent to a grant processing unit 207.

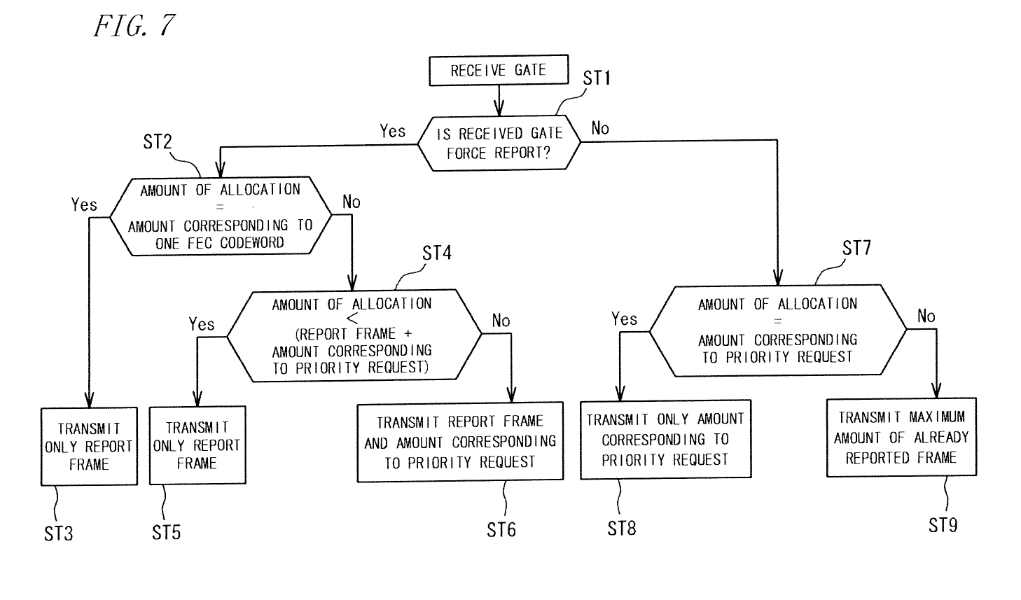

The grant processing unit 207 is to control the frame transmitting unit 206 on the PON side according to an instruction by a grant G. The grant processing unit 207 extracts, from the received grant G, the type thereof G1, G2 (whether it is a force report) and an amount of allocation and determines, based on these pieces of information and the most recent request values R1 and R2 reported by the optical network unit 2 to the optical line terminal 1, content of transmission to the optical line terminal 1. Note that specific details of a process performed by the grant processing unit 207 (FIG. 7) will be described later.

In addition, the optical network unit 2 includes a request processing unit 208 that controls transmission of a report R to the optical line terminal 1; and a threshold value holding unit 209 that stores a threshold value for determining an amount of data requested in the processing unit 208.

The request processing unit 208 determines first and second request values R1 and R2 based on the enqueue status of the upstream frame queue 205 and the threshold value Th held in the threshold value holding unit 209, and specifies those values R1 and R2 in one report R.

The grant processing unit 207 determines whether to allow the frame transmitting unit 206 on the PON side to transmit only the report R or to transmit user data D together therewith, based on an amount of allocation obtained from a grant G1 which is a force report and the content of the last report R generated by the request processing unit 208.

In addition, the grant processing unit 207 determines whether to transmit an amount of data corresponding to only the priority request value R1 or to transmit a larger amount of data than that, based on an amount of allocation obtained from a grant G2 which is not a force report.

[Method for Determining Request Values]

FIG. 8 is a conceptual diagram showing a data accumulation state in the upstream frame queue 205.

In FIG. 8, f1 to f6 indicate variable length frames (in the present embodiment, Ethernet frames with a variable length ranging from 64 to 1518 bytes). In an example of FIG. 8, six variable length frames f1 to f6 are accumulated in the upstream buffer, and the symbols A indicate divisions (boundaries) between the frames f1 to f6.

The request processing unit 208 of the optical network unit 2 determines two request values R1 and R2 based on the accumulation state of the variable length frames f1 to f6 in the upstream frame queue 205.

Specifically, in the accumulation state shown in FIG. 8, the first request value (priority request value) R1 indicates an amount of data corresponding to the division of the variable length frame f2 which is smaller than or equal to and closest to the threshold value Th (=THR1 to THR3) preset in the threshold value holding unit 209. The threshold value Th in this case indicates that if the amount of data is smaller than or equal to this value, then the amount of data is for one of the maximum delay guaranteed bandwidths LB1 to LB3.

On the other hand, the second request value R2 indicates an amount of data corresponding to the division of the variable length frame f6 which is smaller than or equal to and closest to a maximum amount of data (in the example of FIG. 8, the total amount of buffer) of which the optical network unit 2 wants to perform upstream transmission in one grant cycle T.

As such, in the present embodiment, the request values R1 and R2 both indicate the amounts of data coinciding with the divisions of the variable length frames f2 and f6 (the symbols A in FIG. 8).

Therefore, even if dynamic bandwidth allocation is performed where the optical line terminal 1 (the allocation performing unit 110 in the dynamic bandwidth allocating unit 107) generates grants G by adopting request values R1 and R2 of the optical network units 2 to 4 as they are, using variable length frames f1 to f6 as set units, the frames f1 to f6 can be efficiently arranged in a grant cycle T.

This suppresses the occurrence of wasted time resulting from that variable length frames f1 to f6 cannot be aligned and thus the frames f1 to f6 are not placed in a grant cycle T.

[Method for Setting a Threshold Value]

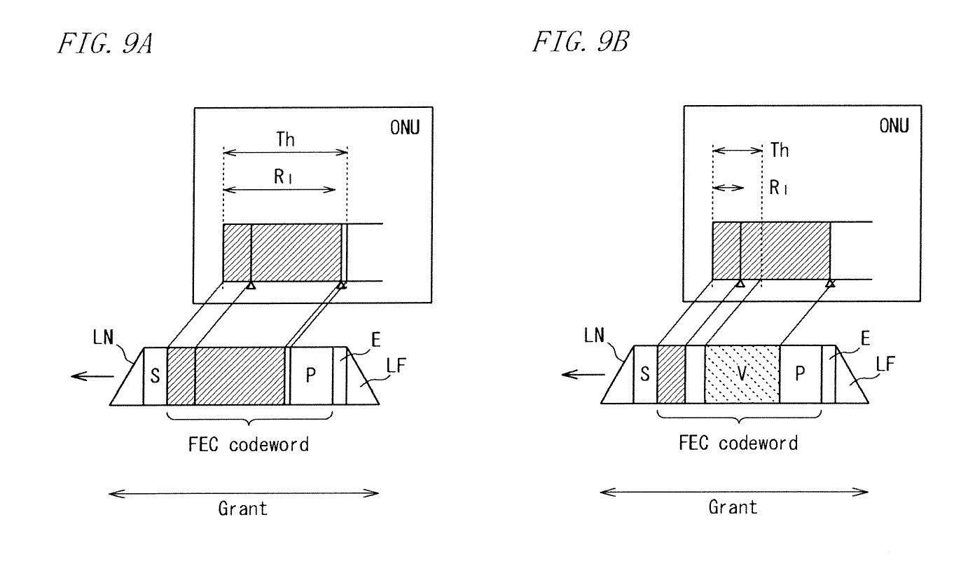

Meanwhile, when the threshold value Th for determining a first request value R1 is set without taking into account the size of the unit amount of data (FCW) of a FEC frame, a blank time where data transmission cannot be performed (e.g., a blank time V shown in FIG. 9B) may become large in an allocated bandwidth granted by the optical line terminal 1, which may degrade bandwidth efficiency.

FIGS. 9A and 9B are correspondence diagrams between the upstream queue state of the optical network units 2 to 4 and an optical burst signal. In FIGS. 9A and 9B, LN indicates laser on time, LF indicates laser off time, S indicates synchronization time, P indicates parity time in one FCW, and E indicates EOP (End of Burst).

As shown in FIG. 9B, when the threshold value Th is set to a very small value compared to the actual amount of data of one FEC code word (one FCW-P), if a grant is performed by adopting a first request value R1 less than or equal to the threshold value Th, then a large blank time V which is not used for data transmission, shown by a dashed hatching area in FIG. 9B inevitably occurs.

On the other hand, if, as shown in FIG. 9A, the threshold value Th is set to a value substantially equal to (one FCW-P), then when a grant is performed by adopting a first request value R1 less than or equal to the threshold value Th, there is almost no blank time V which is not used for data transmission, enabling to prevent degradation in bandwidth efficiency caused by the occurrence of a large blank time in a grant.

Hence, the threshold value holding unit 209 of the present embodiment stores a threshold value Th set to a value corresponding to the actual amount of data that can be included in an N (natural number) EC frame(s).

[Details of a Process of the Grant Processing Unit]

FIG. 7 is a flowchart showing the details of a process performed by the grant processing unit 207 of the optical network unit 2.

As shown in FIG. 7, the grant processing unit 207 first determines, by referring to a flag field in a received grant G, whether the grant G is a force report (a request to transmit a report R), i.e., which one of the aforementioned types (grants G1 and G2) the grant G is of (step ST1 in FIG. 7).

If, as a result of the determination, the grant G is a grant G1 which is a force report (Yes at step ST1 in FIG. 7), then the grant processing unit 207 determines whether an amount of allocation (a value corresponding to a period of time) by the grant G1 is equal to the amount corresponding to one FEC code word (one FCW) (step ST2 in FIG. 7).

Note that since the amount of allocation in the grant G1 is a value corresponding to a period of time, the amount of allocation for one FCW includes, in 1-FCW transmission time, laser rise time, synchronization time, laser fall time, etc.

Then, if the amount of allocation is equal to the amount corresponding to one FCW (Yes at step ST2 in FIG. 7), then the grant processing unit 207 instructs the frame transmitting unit 206 on the PON side to transmit only a report R (step ST3 in FIG. 7).

On the other hand, if the amount of allocation is not equal to the amount corresponding to one FCW (No at step ST2 in FIG. 7), i.e., if the amount of allocation is larger than or equal to the amount corresponding to two FCWs, then the grant processing unit 207 determines whether the amount of allocation is smaller than the total amount of allocation required to transmit a report R and user data D of an amount corresponding to a priority request value R1 (step ST4 in FIG. 7).

If the determination result is affirmative (Yes at step ST4 in FIG. 7), then the grant processing unit 207 instructs the frame transmitting unit 206 on the PON side to transmit only the report R (step ST5 in FIG. 7).

On the other hand, if the determination result is negative (No at step ST4 in FIG. 7), then the grant processing unit 207 instructs the frame transmitting unit 206 on the PON side to transmit the report R and user data D of an amount corresponding to the priority request value R1 (step ST6 in FIG. 7).

Next, if the type of the grant G is a grant G2 which is not a force report (No at step ST1 in FIG. 7), then the grant processing unit 207 determines whether an amount of allocation (a value corresponding to a period of time) by the grant G2 is equal to the amount of allocation required to transmit user data D of an amount corresponding to a priority request value R1 (step ST7 in FIG. 7).

If the determination result is affirmative (Yes at step ST7 in FIG. 7), then the grant processing unit 207 instructs the frame transmitting unit 206 on the PON side to transmit only user data D of an amount corresponding to the priority request value R1 (step ST8 in FIG. 7).

On the other hand, if the determination result is negative (No at step ST7 in FIG. 7), then the grant processing unit 207 instructs the frame transmitting unit 206 on the PON side to transmit a maximum amount of already reported user data D that can be transmitted by the granted amount of allocation (step ST9 in FIG. 7).

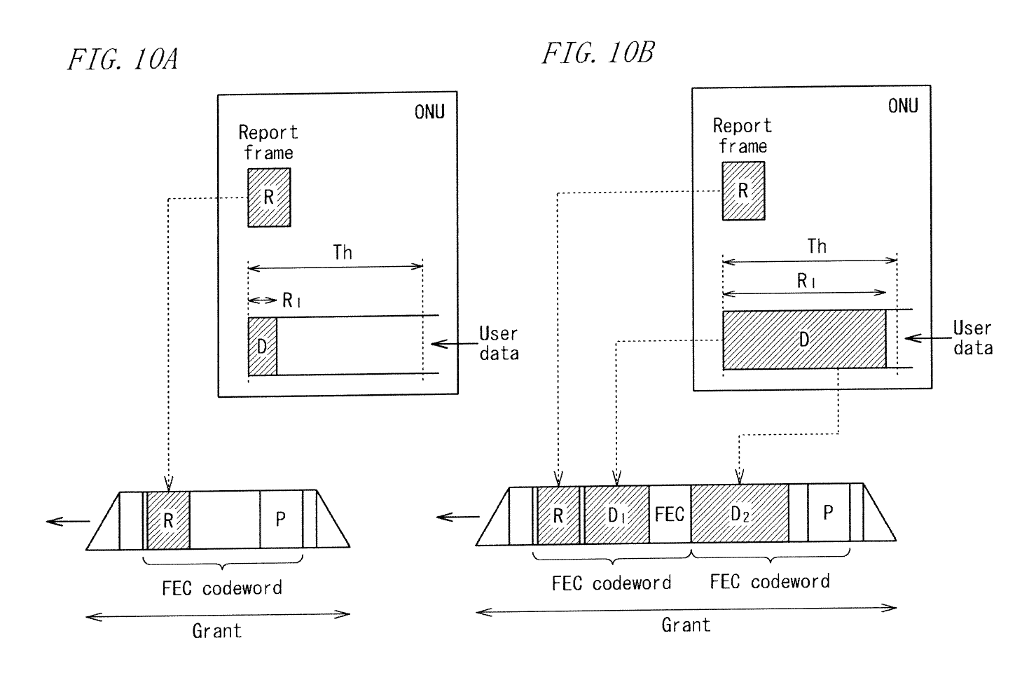

FIGS. 10A and 10B are correspondence diagrams between the upstream queue state of the optical network units 2 to 4 and an optical burst signal. FIG. 10A shows the case of step ST3 in FIG. 7 and FIG. 10B shows the case of step ST6 in FIG. 7.

As shown in FIG. 10A, in the case of step ST3 in FIG. 7, i.e., in the case of receiving a grant G1 which is a force report with an amount of allocation being equal to the amount corresponding to one FCW, even if user data D is accumulated in the queue, the optical network units 2 to 4 each perform upstream transmission of an optical burst signal storing only a report R in one FEC code word.

On the other hand, as shown in FIG. 10B, in the case of step ST6 in FIG. 7, i.e., in the case of receiving a grant G1 which is a force report with an amount of allocation larger than or equal to the amount corresponding to two FCWs and larger than or equal to the sum of a bandwidth for report transmission and a bandwidth for a first request value R1 (a priority request value in the multiple-request scheme), the optical network units 2 to 4 each perform upstream transmission of an optical burst signal storing a report R and an amount of data corresponding to the priority request value R1 in a plurality of FEC code words.

Note that, in an example shown in FIG. 10B, user data D accumulated in the queue is divided into two data units D1 and D2, and the data D1 is stored in the first FCW and the data D2 is stored in the second FCW.

[Effects of the Optical Network Units]

As described above, according to the optical network units 2 to 4 of the present embodiment, the grant processing unit 207 determines whether an amount of allocation specified in a grant G1 which is a force report is one FCW (step ST2 in FIG. 7). If the determination result is affirmative, then the frame transmitting unit 206 transmits only a report R to the optical line terminal 1 (step ST3 in FIG. 7). Therefore, in response to a grant G1 which is a force report, each of the optical network units 2 to 4 does not perform upstream transmission of an amount of data exceeding the amount corresponding to a report R.

Hence, the optical network units 2 to 4 can be prevented from performing upstream transmission of an amount of data that is not expected by the optical line terminal 1, enabling to suppress confusion over bandwidth control caused by the optical line terminal 1 receiving an unexpected amount of data.

In addition, according to the optical network units 2 to 4 of the present embodiment, when an amount of allocation specified in a grant G1 which is a force report is larger than or equal to two FCWs (No at step ST2 in FIG. 7), the grant processing unit 207 determines whether the amount of allocation is larger than or equal to a bandwidth required to transmit an amount of data corresponding to both a report R and a priority request value R1 (step ST4 in FIG. 7). If the amount of allocation is larger than or equal to the bandwidth, then the frame transmitting unit 206 transmits an amount of data corresponding to the report R and the priority request value R1 to the optical line terminal 1 (step ST6 in FIG. 7). Thus, when the optical line terminal 1 has an intention of allowing the optical network units 2 to 4 to transmit user data D by a grant G1 which is a force report, the optical network units 2 to 4 can perform upstream transmission of the user data D in response to the intension.

Furthermore, according to the optical network units 2 to 4 of the present embodiment, the grant processing unit 207 determines whether an amount of allocation specified in a grant G2 which is not a force report is the amount corresponding to a priority request value R1 (step ST7 in FIG. 7). If the determination result is affirmative, then the frame transmitting unit 206 transmits an amount of data corresponding to only the priority request value R1 to the optical line terminal 1 (step ST8 in FIG. 7). Thus, in response to a grant G2 which is not a force report, each of the optical network units 2 to 4 does not perform upstream transmission of an amount of data exceeding the amount corresponding to a priority request value R1.

Hence, in dynamic bandwidth allocation of the multiple-request scheme, the optical network units 2 to 4 can be prevented from performing upstream transmission of an amount of data that is not expected by the optical line terminal 1, enabling to suppress confusion over bandwidth control caused by the optical line terminal 1 receiving an unexpected amount of data.

[Other Variants]

The embodiment disclosed herein is an illustration and not a restriction of the present invention. The scope of the present invention is indicated by the appended claims rather than the embodiment, and all changes which come within the meaning and range of equivalency of the claims and the configurations thereof are therefore intended to be embraced therein.

For example, the optical network units of the present invention can also be adopted in a PON system that performs bandwidth allocation by a report R specifying only a single request value.

### REFERENCE SIGNS LIST

1: OPTICAL LINE TERMINAL

2 to 4: OPTICAL NETWORK UNIT

6: OPTICAL COUPLER

107: DYNAMIC BANDWIDTH ALLOCATING UNIT

110: ALLOCATION PERFORMING UNIT

206: FRAME TRANSMITTING UNIT

207: GRANT PROCESSING UNIT

208: REQUEST PROCESSING UNIT

209: THRESHOLD VALUE HOLDING UNIT

B1 to B3: MINIMUM GUARANTEED BANDWIDTH

LB1 to LB3: MAXIMUM DELAY GUARANTEED BANDWIDTH

THR1 to THR3: THRESHOLD VALUE FOR DETERMINING PRIORITY REQUEST VALUE

R1: FIRST REQUEST VALUE (PRIORITY REQUEST VALUE)

R2: SECOND REQUEST VALUE

R: REPORT

G: GRANT

G1: GRANT WHICH IS A FORCE REPORT

G2: GRANT WHICH IS NOT A FORCE REPORT

D: USER DATA

1. An optical network unit in a PON system, the optical network unit being capable of performing bidirectional optical communication with an optical line terminal through a passive light splitting node, and performing upstream transmission of a FEC frame including a variable length frame to the optical line terminal, and comprising:
a grant processing unit that determines whether an amount of allocation specified in a grant is one unit amount of data of the FEC frame, the grant being a report request; and
a frame transmitting unit that transmits only a report to the optical line terminal if a result of the determination is affirmative.

2. The optical network unit according to claim 1, further comprising:
a threshold value setting unit that sets a threshold value to a value corresponding to an actual amount of data that can be included in a natural number of FEC frames; and
a request processing unit that sets, as a request value specified in the report, an amount of data corresponding to a division of one of variable length frames smaller than or equal to and closest to the set threshold value.

3. The optical network unit according to claim 2, wherein
the request processing unit can set a plurality of request values in one of the report, the plurality of request values including a priority request value for maximum delay guarantee,
the grant processing unit determines whether the amount of allocation specified in the grant is larger than or equal to two unit amounts of data of the FEC frames and larger than or equal to a bandwidth required to transmit an amount of data corresponding to both the report and the priority request value, the grant being a report request, and
if a result of the determination is affirmative, then the frame transmitting unit transmits an amount of data corresponding to the report and the priority request value to the optical line terminal.

4. The optical network unit according to claim 3, wherein
the grant processing unit determines whether an amount of allocation specified in a grant is an amount corresponding to the priority request value, the grant being not a report request, and
if a result of the determination is affirmative, then the frame transmitting unit transmits an amount of data corresponding to only the priority request value to the optical line terminal.

5. A PON system comprising: an optical line terminal; and a plurality of optical network units performing bidirectional optical communication with the optical line terminal through a passive light-splitting node, the optical network units each performing upstream transmission of a FEC frame including a variable length frame to the optical line terminal, wherein
when any of the optical network units receives a grant and an amount of allocation specified in the grant is one unit amount of data of the FEC frame, the optical network unit transmits only a report to the optical line terminal, the grant being a report request.

6. A transmission control method for an optical network unit performed when the optical network unit performing bidirectional optical communication with an optical line terminal through a passive light-splitting node performs upstream transmission of a FEC frame including a variable length frame, based on a grant received from the optical line terminal, the transmission control method comprising:
allowing the optical network unit to transmit only a report when an amount of allocation specified in the grant is one unit amount of data of the FEC frame, the grant being a report request.
